(19) United States
(12) Patent Application Publication
(10) Pub. No.: US 2014/0173980 A1
(43) Pub. Date: Jun. 26, 2014

(54) COMPOSITIONS AND METHODS FOR INDUCING PREFERENTIAL ROOT TROPISM

(71) Applicants: Cesare CEJAS, Langhorne, PA (US); Remi DREYFUS, Philadelphia, PA (US); Lawrence HOUGH, Philadelphia, PA (US); Jean-Christophe CASTAING, Sevres (FR)

(72) Inventors: Cesare CEJAS, Langhorne, PA (US); Remi DREYFUS, Philadelphia, PA (US); Lawrence HOUGH, Philadelphia, PA (US); Jean-Christophe CASTAING, Sevres (FR)

(73) Assignees: CENTRE NATIONALE DE LA RECHERCHE SCIENTIFIQUE, Paris (FR); RHODIA OPERATIONS, Aubervilliers (FR)

(21) Appl. No.: 14/136,566

(22) Filed: Dec. 20, 2013

Related U.S. Application Data
(60) Provisional application No. 61/739,887, filed on Dec. 20, 2012.

(51) Int. Cl. A01G 1/00

(52) U.S. Cl. CPC A01G 1/001
USPC 47/58.1 R

(57) ABSTRACT

Disclosed are methods and devices that can improve water usage by plants and grasses by, for example, inducing preferential root tropism and assisting in redistributing water within the soil.

### CROSS REFERENCE TO RELATED APPLICATIONS

This claims the benefit of U.S. Provisional Patent Application No. 61/739,887 filed Dec. 20, 2012, incorporated herein by reference in its entirety.

### FIELD OF THE INVENTION

This invention relates to intrusions and methods of use useful in the promotion of seed germination, plant and crop yield, as well as in the efficient use of water by plants, shrubs, crops and general agriculture.

### BACKGROUND OF THE INVENTION

Water scarcity is a major constraint to human and agricultural development. Roughly 70% of the fresh water consumed is directed towards agricultural-related usage, for example as irrigation water, which in turn accounts for roughly 90% of agricultural usage. As the demand for fresh water through agricultural development as well as human development increases, more effective and efficient uses of water are becoming necessary. This need is even more pronounced in light of the increasing scarcity of fresh water. Accordingly, there is a growing need for an improved and more efficient usage of fresh water.

Some of the water used in agriculture is lost by evaporation, infiltration, drainage, and water runoff. What remains can be absorbed by plants, grasses and trees, which are utilized for harvest production.

Efficient usage of water in agriculture has not only a sizable ecological impact, but has also an impact on agricultural economies as there is a direct correlation between the quantity of water available to the plants and their yield. If water is drawn or confined at the plant's root level for a longer time, there should be a direct effect on crop production and yield. During critical conditions, an optimized usage of water and increased water availability can secure the crop from complete destruction and loss of harvest.

One traditional solution is through the use of additives, often in the form of superabsorbent hydrogels mixed and infused with the soil, wherein these superabsorbent hydrogels are capable of absorbing water when exposed to water. Common superabsorbent hydrogels for agriculture are based on acrylamide or acrylate polymeric structures, which are commercially synthesized in such a manner that results in it being super-porous. While they swell in the presence of water, the super-porous characteristic of these hydrogels often leads to their extreme fragility. They absorb large quantities of water that allow expansion. The constant cycle of swelling and de-swelling make commercial hydrogels often susceptible to breakage.

It has generally been recognized (e.g., by farmers) that the use of superabsorbent hydrogels increase water retention capacity of soils. However, the direct relation of using these hydrogels with root growth viability is not obvious. It has only been suggested but not explicitly demonstrated.

Accordingly, there is a need for an improved method and devices that can improve water usage by plants and grasses by, for example, inducing preferential root tropism and assisting in re-distributing water within the soil.

### SUMMARY OF INVENTION

The invention relates to methods for improving yield, root growth and/or germination rates of crops, as well as agricultural and horticultural plants, shrubs, trees and grasses (hereinafter sometimes collectively referred to as “plants”). Applications targeted include but are not limited to agricultural uses to increase the yield of crops or plants or to secure the crop or plant in very hostile areas (non irrigated zones, warm to hot climates, windy areas, scarce precipitation, or a combination of these). Targeted markets include but are not limited to: agriculture for non-irrigated crops (including but not limited to wheat, cotton, etc); agriculture for irrigated crops (including but not limited to horticulture-based plants); arboriculture, forestry and gardening; golf courses; sport and park turf; nurseries, seedling promoters for plant nurseries; and fruits, among others. The methods described herein are capable of increasing the agricultural yield, horticultural yield and/or crop or plant yield in a target soil area.

Instead of relying on polyacrylamide gels, another strategy to increase yield, root growth and/or germination rates is to re-distribute the water already present in the soil. Water in soil, through gravity, seeps beneath the soil surface, often several meters deep below the roots and eventually gets collected in and around the water table. By introducing techniques and devices, water from the water table can be re-distributed closer to the roots and/or preferential tropism of roots can be induced deeper into the ground or in some preferred pattern of growth, or in some desired area/location. Such techniques allow taking advantage of already existing natural biological phenomena (e.g. gravitropism) to improve root growth and enhance root mortality.

In one embodiment, described herein are methods and devices capable of improving of root growth by inducing preferential tropism through the use of certain techniques, particularly introducing inhomogeneities. Results are currently based on a model system consisting of a two-dimensional (2D) granular medium of monodisperse and monolayer glass bead matrix. In one embodiment, techniques to enhance preferential tropism are based on a solid square tube that is inserted into the 2D medium. The size of the square tube is roughly the same as the thickness of the medium. The geometry of the tube favors an unobstructed capillary flow along the exterior wall, which proves favorable with the growth dynamics of the root.

In one aspect, described herein are methods of increasing root length of a plant and/or inducing root tropism, the method comprising: inserting at least a portion of a root device in the ground proximate to a seed or plant (or proximate to where a seed or plant is intended to be planted). The root device is a structure that extends in a substantially longitudinal direction.

In another aspect, described herein are methods of inducing tropism of a plant root towards a water reservoir in soil, the method comprising: inserting at least a portion of a root device in the ground proximate to a seed or plant (or proximate to where a seed or plant is intended to be planted). The root device is a structure that extends in a substantially longitudinal direction.

In another aspect, described herein are methods of promoting the growth of a root towards water in soil, the method comprising: inserting at least a portion of a root device in the ground proximate to a seed or plant (or proximate to where a seed or plant is intended to be planted). The root device is a structure that extends in a substantially longitudinal direction.

In another aspect, described herein are methods of increasing the lifespan of a plant, the method comprising: inserting at least a portion of a root device in the ground proximate to a seed or plant (or proximate to where a seed or plant is intended to be planted). The root device is a structure that extends in a substantially longitudinal direction.

In one embodiment, the root device has an average cross-sectional diameter greater than about 0.1 mm. In other embodiments, the root device has an average cross-sectional diameter greater than about 0.2 mm, 0.4 mm, 0.6 mm, 0.8 mm, 1 mm, 2 mm, 4 mm, 6 mm, 8 mm, 1 cm, 3 cm, 6 cm, 8 cm, 10 cm, 12 cm or 15 cm.

In some embodiments, the root device has an average cross-sectional diameter of from 0.1 mm to 5 mm, or has an average cross-sectional diameter of from 0.2 mm, or in other embodiments has an average cross-sectional diameter of from 0.2 mm to 2 mm.

In another embodiment, the structure comprises a tube having a proximal end and a distal end and having at least one perforation. The at least one perforation has a diameter or width of less than 2 mm or 1 mm or 500 μm or 100 μm or 70 μm or 50 μm or 25 μm or 10 μm or 5 μm or 2 μm or 1 μm or 0.1 μm. The tube can further comprise an inner wall and an outer wall.

In some embodiments, the perforation has a diameter or width of less than 50% of an average soil particle size in the soil.

In one embodiment, the structure comprises a thin-walled tube. The structure can able be of any suitable cross-sectional shape, for example, the structure can have a substantially circular, square, oval, triangular cross-sectional area. In one particular embodiment, the structure comprises at least one longitudinal wall.

In another aspect, described herein are methods of increasing root length of a plant and/or inducing root tropism, the method comprising: contacting a plant or a seed with soil; and inserting at least a portion of a root device in the soil proximate to the seed or the plant. The root device has a structure extending in a substantially longitudinal direction, where the structure, in one embodiment, comprises a thin-walled tube or comprises at least one wall.

In yet another aspect, described herein are methods of increasing root length of a plant and/or inducing root tropism, the method comprising inserting at least a portion of a root device in soil; and contacting a plant or a seed with soil proximate to the root device; wherein the root device comprises a structure extending in a substantially longitudinal direction.

In one further aspect, described herein are devices for increasing the root length of a plant (or inducing root tropism), where the devices is structure extending in a substantially longitudinal direction, and having a cross-sectional area comprising an outer wall and an inner wall. The cross-sectional area can be any suitable shape including but not limited to being substantially square, oval, circular, triangular, or trapezoidial in shape.

It is understood that the term “root device” is also herein referred to as “intrusion” and can be used interchangeably.

### BRIEF DESCRIPTION OF DRAWINGS

FIG. 1 is a depiction based on a photograph illustrating the effects of use of the root device in promoting root growth and root tropism versus no root device.

FIG. 2 is a graph showing the primary root length versus time (days) along with a pictorial representation.

FIG. 3 is a graph showing the total root length versus time (days) along with a pictorial representation.

FIG. 4 is a depiction based on a photograph that, in one embodiment, illustrates the growth-induced tropism proximate the root device.

FIG. 5 is a depiction based on a photograph of, in one embodiment, a 1 mm root device wherein a liquid film (illustrating capillary action) between the root device and surrounding medium, e.g., monolayer of glass beads as model soil (1 mm±0.2 mm).

FIG. 6 is, in one embodiment, a diagram of the root device.

FIG. 7 is a diagram of the root structure device in another embodiment, comprising a substantially solid structure without perforations.

### DETAILED DESCRIPTION OF INVENTION

The present invention relates to methods and devices that are useful to improve germination rates of plants and crops.

As described and claimed herein, it is possible to induce preferential tropism in roots for more robust growth by introducing solid inhomogeneities in the soil. These solid inhomogeneities change water distribution in the granular media.

Most of the prior solutions have been focused on water re-distribution through the use of chemical additives and irrigation devices. While this remains crucial in every aspect, none of these patents have actually claimed a clear and direct impact and improvement on root growth. This application, however, neither does claim nor recommend the use of a square intrusion or root device as an alternative technique to be actually used in real fields for promoting root growth. What is strongly suggested, from experimental results based on controlled model systems, is that modification of a soil structure through the introduction of inhomogeneities such as the invention described herein can induce preferential growth tropism and guide roots to more saturated regions, resulting in a more robust growth.

According to the invention, it is possible to induce preferential tropism in roots for more robust growth by introducing solid inhomogeneities in the soil.

In one embodiment, described herein are methods and devices capable of improving of root growth by inducing preferential tropism through the use of certain techniques and devices. As described herein, “preferential tropism” means that a growth or turning movement of a biological organism, specifically of a plant root or plant root system, in response to an environmental stimulus. The environmental stimulus in question is the loss of water due to evaporation or by any other means. The lack of water induces some hydraulic stress upon the root. Because the root device allows for capillary flow along its exterior walls, the root senses this capillary water activity and moves in the direction of the intrusion. In one embodiment, the root device as described herein aids the plant root in responding to the stimulus (lack of water) by guiding it to areas of greater saturation.

The experimental results described herein are based on a model system consisting of a two-dimensional (2D) granular medium of monodisperse and monolayer glass bead matrix. In some examples, the monolayer of glass beads having cross sectional diameter or width of 1 mm±0.2 mm is utilized as model soil. In one embodiment, techniques to enhance preferential tropism are based on a solid square tube that is inserted into the 2D medium. The size of the square tube is roughly the same as the thickness of the medium. The geometry of the square tube favors an unobstructed capillary flow, which proves favorable with the growth dynamics of the root.

Generally, water loss can be attributable to transpiration, evaporation or runoff through drainage channels in the soil. Many of the known methods that prevent water loss through drainage are correlated to the nature of the targeted soils and well as local climate conditions. For example, arable and cultivable lands in the United States are predominately of the sandy type. However, in China and South East Asia, lands are mostly of the clay type. Clay soils in general have a different soil structure than sandy soils as the average particle size of clay soils, and thus pore size, is smaller. Generally, in some embodiments, clay soils have a mean particle diameter (D₅₀) of less than 50 micrometers. In other embodiments, clay soils have a mean particle diameter (D₅₀) of about or less than 25 micrometers. More typically, clay soils have a mean particle diameter of about or less than 5 micrometers. On the contrary, sandy soil is generally characterized, in some embodiments, by round grains with particle sizes ranging from 100 micrometers to 2000 micrometers. There are other differences between sandy, clay, as well as other types of soils, as generally described below. For example, for gravel the average soil particle diameter in some embodiments is between greater than about 2 mm, or greater than about 1 mm.

Sandy Soils: Generally, sandy soils have a gritty texture and are formed from weathered rocks such as limestone, quartz, granite, and shale. Sandy soils can contain sufficient to substantial organic matter, which makes it relatively easy to cultivate. Sandy soils, however, are prone to over-draining and dehydration, and can have problems retaining moisture and nutrients. In some embodiments, sandy soil has an average soil particle diameter of between about 0.05 mm to about 2 mm, or about 0.025 to about 2.5 mm.

Silty Soil: Generally, silty soil is considered to be among the more fertile of soils. Silty soil is generally composed of minerals (predominantly quartz) and fine organic particles, and it has more nutrients than sandy soil offers good drainage. When dry it has rather a smooth texture and looks like dark sand. Its weak soil structure means that it is easy to work with when moist and it holds moisture well. In some embodiments, silty soil has an average soil particle diameter of between about 0.002 mm to about 0.05 mm, or about 0.001 to about 0.06 mm.

Clay (or Clayey) Soil: When clay soils are wet they are generally sticky, lumpy and pliable but when they dry they generally form hard clots. Clay soils are composed of very fine particles with few air spaces, thus they are hard to work and often drain poorly—they are also prone to water logging in spring. Blue or grey clays have poor aeration and must be loosened in order to support healthy growth. Red color in clay soil indicates good aeration and a “loose” soil that drains well. As clay contains high nutrient levels plants grow well if drainage is adequate. In some embodiments, clay soil has an average soil particle diameter of less than 0.002 mm.

Peaty Soil: Peaty soil generally contains more organic material than other soils because its acidity inhibits the process of decomposition. This type of soils contains fewer nutrients than many other soils and is prone to over-retaining water.

Loamy Soil: Generally, loamy soils are a combination of roughly 40% sand, 40% silt and 20% clay. Loamy soils can range from easily workable fertile soils full of organic matter, to densely packed sod. Generally, they drain yet retain moisture and are nutrient rich.

Chalky Soil: Chalky soils are generally alkaline and may contain a variety of different sized stones. These types of soil can dry out quickly and have a tendency to block trace elements such as iron and manganese. This can cause poor growth and yellowing of leaves, as the nutrients are generally not available to the plants. Chalky soil is generally regarded as poor quality, needing substantial addition of fertilizers and other soil improvers.

Described herein are methods of increasing root length of a plant and/or inducing root tropism. Increasing the root length, in one embodiment, means that that the root length is increased in a vertical direction, generally downwards towards the water table; but it can also include in a general horizontal direction or in any other direction. However, it is understood that increasing root length, in another embodiment, means that the total root length is increased wherein there is no general direction that the root length travels. The method comprises inserting at least a portion of a root device in the ground or soil. The root device can, in some embodiments, be proximate or close to a seed or plant.

It is understood that the root device can be inserted, in part of completely, into the soil or ground prior to contacting the seed or plant with the soil or ground. In some other embodiments, the root device is inserted, in part of completely, into the soil or ground after contacting the seed or plant with the soil or ground.

Also described herein are root devices for increasing the root length of a plant and/or inducing root tropism. The root device, in one embodiment, is solid or substantially solid structure, extending in a substantially longitudinal direction, and having a certain cross-sectional area. The root device or structure can be made of any suitable material, including but not limited to plastic, metal, wood, or a combination thereof, or made at least partially of inorganic or organic material.

The cross-sectional area can be any suitable shape including but not limited to being substantially square, oval, circular, triangular, pentagonal, or octagonal in shape. The structure can be straight or substantially straight in the longitudinal direction. It is also understood that the structure can be curved, bowed, bent, twisted, arched, undulating and/or kinked, or have portions that are can be curved, bowed, bent, twisted, arched, undulating and/or kinked.

In another embodiment, the root device can comprise a structure that is at least partially capable of gelling, for example, a polysaccharide. The root device or structure can, in other embodiments, at least partially comprise an organic material. In one embodiment, the root device or structure is comprised completely or partially of wet foam. In an additional embodiment, the root device or structure is comprised completely or partially of dry foam, or in other embodiments comprised at least partially of a combination of wet foam and dry foam. In yet another embodiment, the root device or structure is comprised of nanoparticles, microparticles or a combination thereof. The nanoparticles, microparticles or a combination thereof in such embodiment is packed vertically. However it is also understood that the nanoparticles, microparticles or a combination thereof can be packed in any desired form or direction.

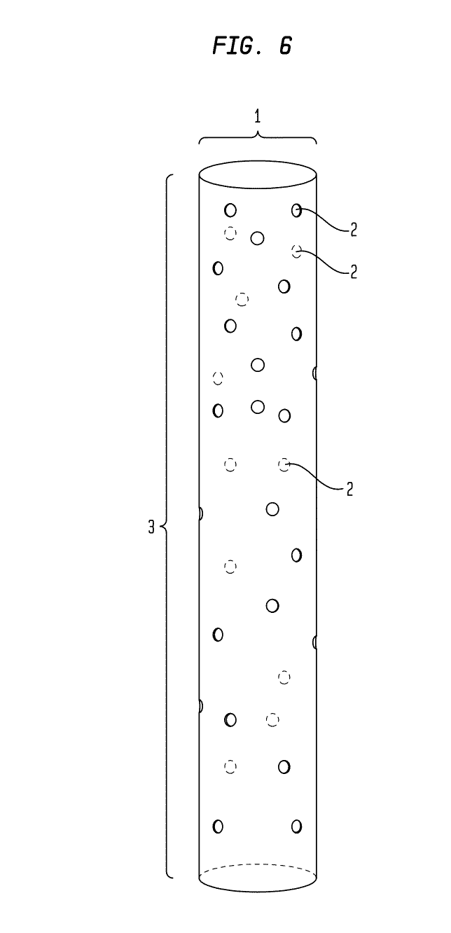

The root device, in another embodiment, is structure extending in a substantially longitudinal direction. Referring to FIG. 6, in one embodiment, the structure is has a length 3 with a cross-sectional diameter 1 and at least one perforation 2. In another embodiment, the structure has having a cross-sectional area comprising an outer wall and an inner wall. In some embodiments, the root device has an average cross-sectional diameter 1 of from 0.1 mm to 5 mm, or has an average cross-sectional diameter 1 of from 0.2 mm to 4 mm, or in other embodiments has an average cross-sectional diameter 1 of from 0.2 mm to 2 mm. In other embodiments, wherein the cross-section is not in the shape of a circle or oval, it is understood that the cross-sectional diameter 1 is replaced with a cross-sectional width. The cross sectional width, in some embodiments, is from 0.1 mm to 5 mm, or from 0.2 mm to 4 mm, or from 0.2 mm to 2 mm.

In another embodiment, the structure comprises a tube having a proximal end and a distal end and having at least one perforation 2. The at least one perforation 2 has an average diameter or width of less than 2 mm or 1 mm or 500 μm or 100 μm or 70 μm or 50 μm or 25 μm or 10 μm or 5 μm or 2 μm or 1 μm or 0.1 μm. The tube can further comprise an inner wall and an outer wall.

The cross-sectional area can be any suitable shape including but not limited to being substantially square, oval, circular, and triangular in shape.

In one embodiment, the root device is has a length 3 or overall length 3 equal to or greater than about 2 cm, 3 cm, 4 cm, 5 cm, 6 cm, 7 cm, 8 cm, 9 cm, 10 cm, 13 cm, 15 cm, 18 cm, or 20 cm. In other embodiments, the root device is has a length 3 equal to or greater than about 20 cm. In another embodiment, the length 3 is less than 1 m, less than 0.5 m, less than 0.1 m or less than 0.05 m. The length 3 should be sufficient to link the distance between the reservoir and the root. The cross-section should be smaller than the size of the pore to induce capillarity action or properties.

The structure, in some embodiments, has an average cross-sectional area of from 10 cm by 0.1 cm.

In one embodiment, the root device has an average cross-sectional diameter 1 greater than about 0.1 mm. In other embodiments, the root device has an average cross-sectional diameter 1 greater than about 0.2 mm, 0.4 mm, 0.6 mm, 0.8 mm, 1 mm, 2 mm, 4 mm, 6 mm, 8 mm, 1 cm, 3 cm, 6 cm, 8 cm, 10 cm, 12 cm or 15 cm.

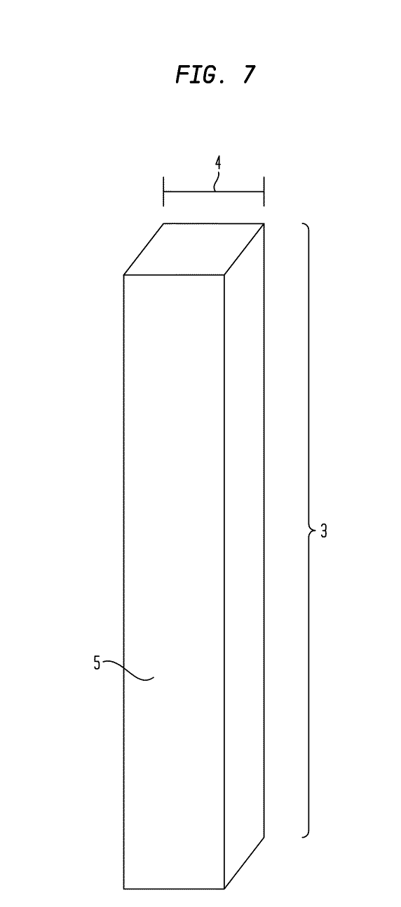

Referring to FIG. 7, another one embodiment, the structure is has a length 3 with a cross-sectional width 4 and at least one wall 5.

In one embodiment, the structure comprises a thin-walled tube. The structure can able be of any suitable cross-sectional shape, for example, the structure can have a substantially circular, square, oval, triangular cross-sectional area. In one particular embodiment, the structure comprises at least one longitudinal wall.

The seed can be any useful or known plant or crop seed. In one embodiment, the seed used in the methods described herein fall into one of three categories: (1) ornamental (such as roses, tulips, etc.), grasses and non-crop seed; (2) broad crop and cereal seeds and (3) horticulture and vegetable seeds. In one particular embodiment, the crop seed is selected from the seed of the species or subspecies Brassica rapa, Brassica chinensis and Brassica pekinensis.

In one embodiment, the seed is of the crop or plant species including but not limited to corn (Zea mays), Brassica sp. (e.g., B. napus, B. rapa, B. juncea), alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Cofea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, woody plants such as conifers and deciduous trees, squash, pumpkin, hemp, zucchini, apple, pear, quince, melon, plum, cherry, peach, nectarine, apricot, strawberry, grape, raspberry, blackberry, soybean, sorghum, sugarcane, rapeseed, clover, carrot, and Arabidopsis thaliana.

In one embodiment, the seed is of any vegetables species including but not limited to tomatoes (Lycopersicon esculentum), lettuce (e.g., Lactuca sativa), green beans (Phaseolus vulgaris), lima beans (Phaseolus limensis), peas (Lathyrus spp.), cauliflower, broccoli, turnip, radish, spinach, asparagus, onion, garlic, pepper, celery, and members of the genus Cucumis such as cucumber (C. sativus), cantaloupe (C. cantalupensis), and musk melon (C. melo).

In one embodiment, the seed is of any ornamentals species including but not limited to hydrangea (Macrophylla hydrangea), hibiscus (Hibiscus rosasanensis), petunias (Petunia hybrida), roses (Rosa spp.), azalea (Rhododendron spp.), tulips (Tulipa spp.), daffodils (Narcissus spp.), carnation (Dianthus caryophyllus), poinsettia (Euphorbia pulcherrima), and chrysanthemum.

In one embodiment, the seed is of any conifer species including but not limited to conifers pines such as loblolly pine (Pinus taeda), slash pine (Pinus elliotii), ponderosa pine (Pinus ponderosa), lodgepole pine (Pinus contorta), and Monterey pine (Pinus radiata), Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis).

In one embodiment, the seed is of any leguminous plant species including but not limited beans and peas. Beans include guar, locust bean, fenugreek, soybean, garden beans, cowpea, mungbean, lima bean, fava bean, lentils, chickpea, pea, moth bean, broad bean, kidney bean, lentil, dry bean, etc. Legumes include, but are not limited to, Arachis, e.g., peanuts, Vicia, e.g., crown vetch, hairy vetch, adzuki bean, mung bean, and chickpea, Lupinus, e.g., lupine, trifolium, Phaseolus, e.g., common bean and lima bean, Pisum, e.g., field bean, Melilotus, e.g., clover, Medicago, e.g., alfalfa, Lotus, e.g., trefoil, lens (e.g., lens cultaris), e.g., lentil, and false indigo. Typical forage and turf grass for use in the methods described herein include but are not limited to alfalfa, orchard grass, tall fescue, perennial ryegrass, creeping bent grass, lucerne, birdsfoot trefoil, clover, stylosanthes species, lotononis bainessii, sainfoin and redtop. Other grass sspecies include barley, wheat, oat, rye, orchard grass, guinea grass, sorghum or turf grass plant.

In another embodiment, the seed is selected from the following crops or vegetables: corn, wheat, sorghum, soybean, tomato, cauliflower, radish, cabbage, canola, lettuce, rye grass, grass, rice, cotton, sunflower and the like.

In some embodiments, the method included inserting at least part of the root device into the ground or soil to a predetermined depth. For example, in some embodiments, the predetermined depth that is included in the soil can be less than 3 ft of depth of soil, in another embodiment less than 2 ft of depth of soil, in another embodiment less than 18 inches of depth of soil, in another embodiment less than 16 inches of depth of soil, in another embodiment less than 12 inches of depth of soil, in another embodiment less than 9 inches of depth of soil, in another embodiment less than 7 inches of depth of soil, in another embodiment less than 5 inches of depth of soil, in another embodiment less than 3 inches of depth of soil, in another embodiment less than 2 inches of depth of soil, or in yet another embodiment less than 1 inch of depth of soil.

Without being bound by theory, it is believed that the root device acts as a link between a water saturated layer beneath the root system and the root system itself, thus providing the root systems with water and nutrients. The capillary flow effectuated by the root device in the soil allow for water migration.

Without being bound by theory, it is also believed that preferential tropism is an effect that results to greater and more robust root lengths. This can be induced by the addition of an inhomogeneity in the soil such as a structural intrusion. The structural intrusion is not limited to a device composed of pore spaces smaller than that of the bulk but can also be made up of hydrophilic or hydrophobic portion of the device. A structural intrusion or inhomogeneity can modify water distribution by maintaining robust water flow or content around and encourage preferential tropism to take effect.

Experiments.

Experiments were conducted as a model soil system of monolayer glass beads (1 mm±0.2 mm) as a substantially 2D model. The experimental dimensions were glass plates having an opening width of 1.2 mm a height of 15 cm and a length of 10 cm. The glass beads (1 mm±0.2 mm) formed a thin layer or monolayer between the glass plates. The seed planted was of the variety: Lens culinaris. The roots grew along the pore spacing between the monolayer glass beads.

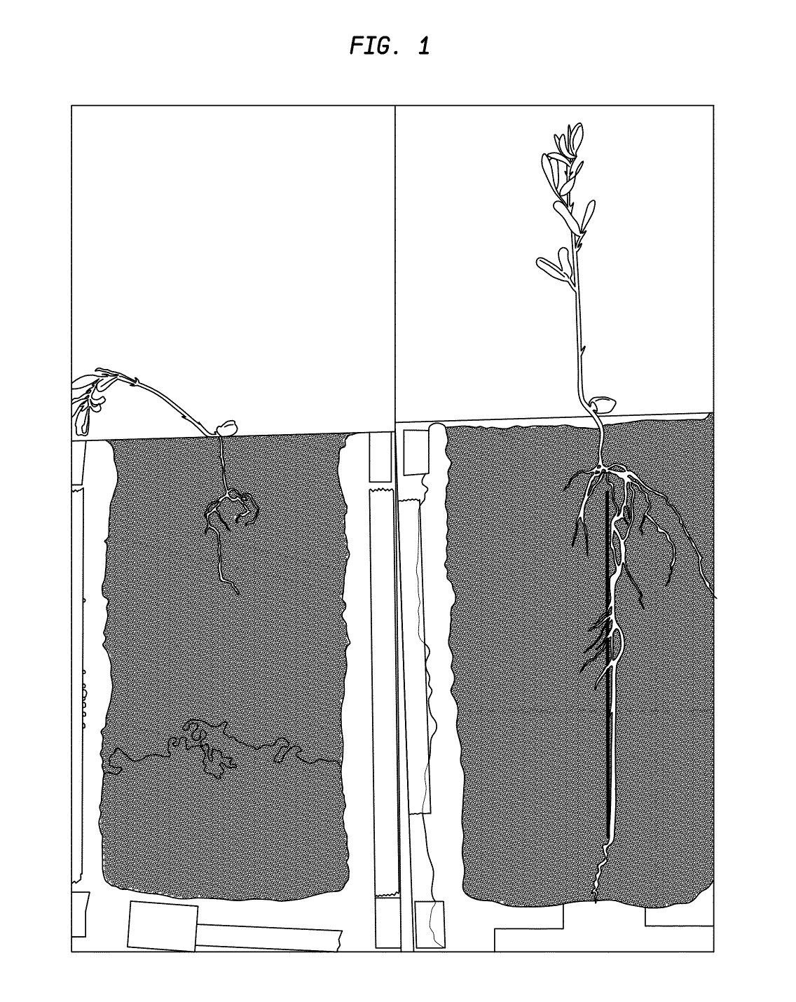

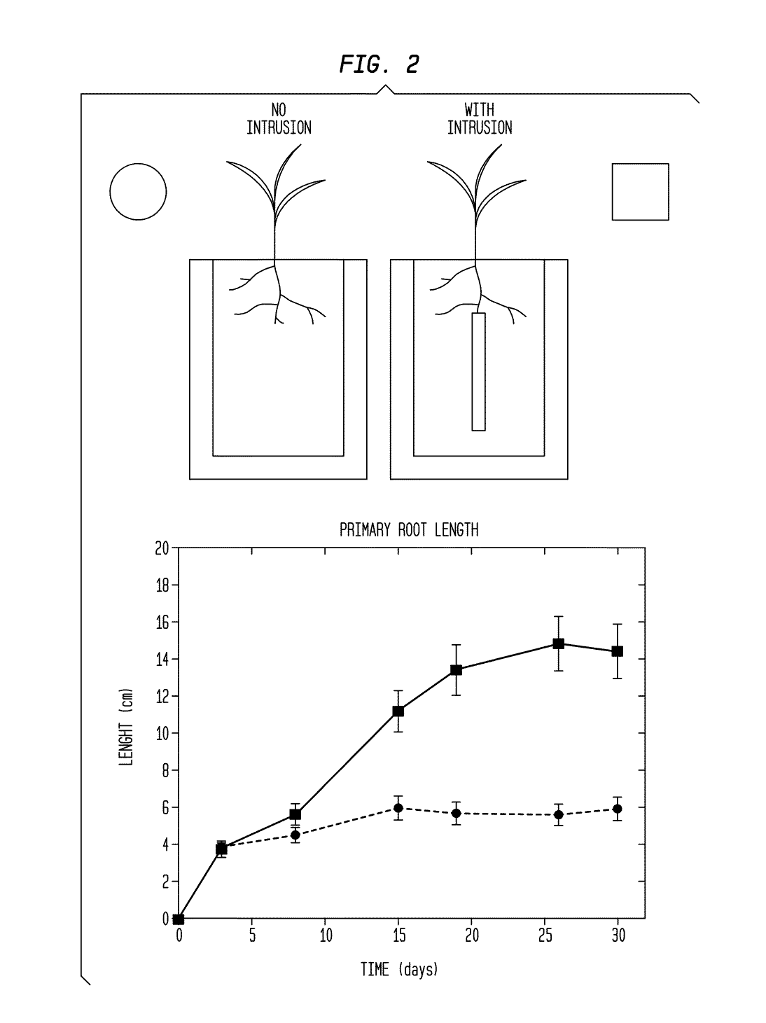

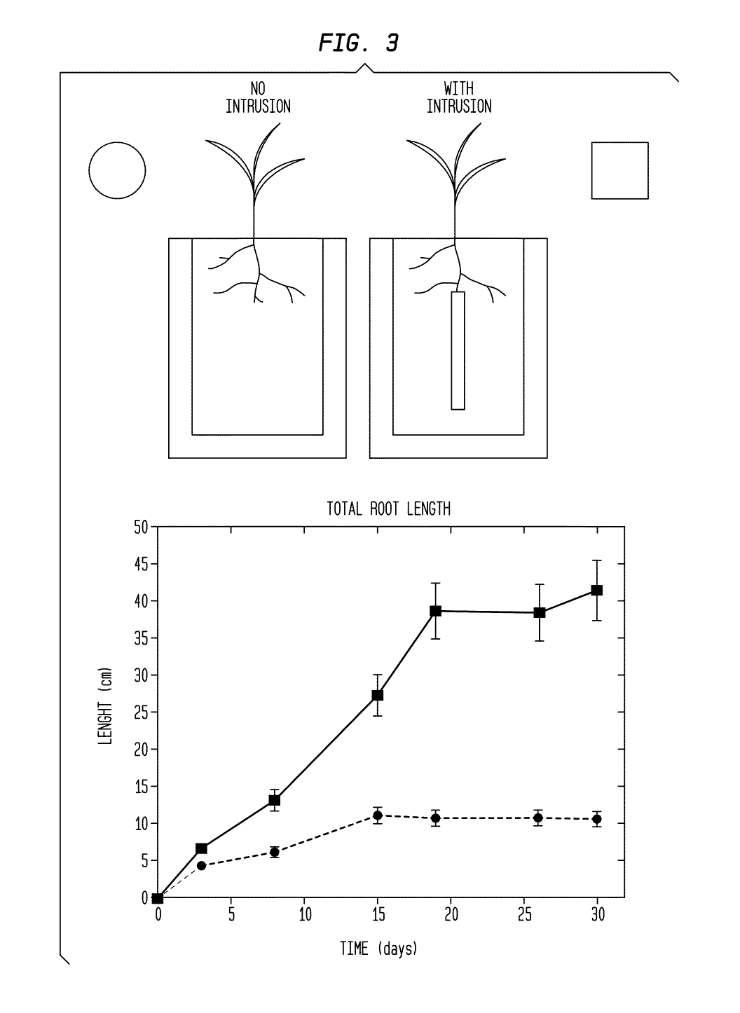

Referring to FIG. 1, illustrated is a photograph illustrating showing the effects of use of the root device in promoting root growth and root tropism versus no root device. As observed after 30 days, the root system in the model soil system having the root device had a longer primary root length and showed preferential growth adjacent to the root device and as a result greater total root length. Specifically, FIG. 2, a graph of the primary root length versus time (days), shows longer primary root length in the system containing the root device or intrusion as compared with the comparative example having no root device or intrusion. FIG. 3, a graph of total root length versus time (days), shows greater total root length in the system containing the root device or intrusion as compared with the comparative example having no root device or intrusion.

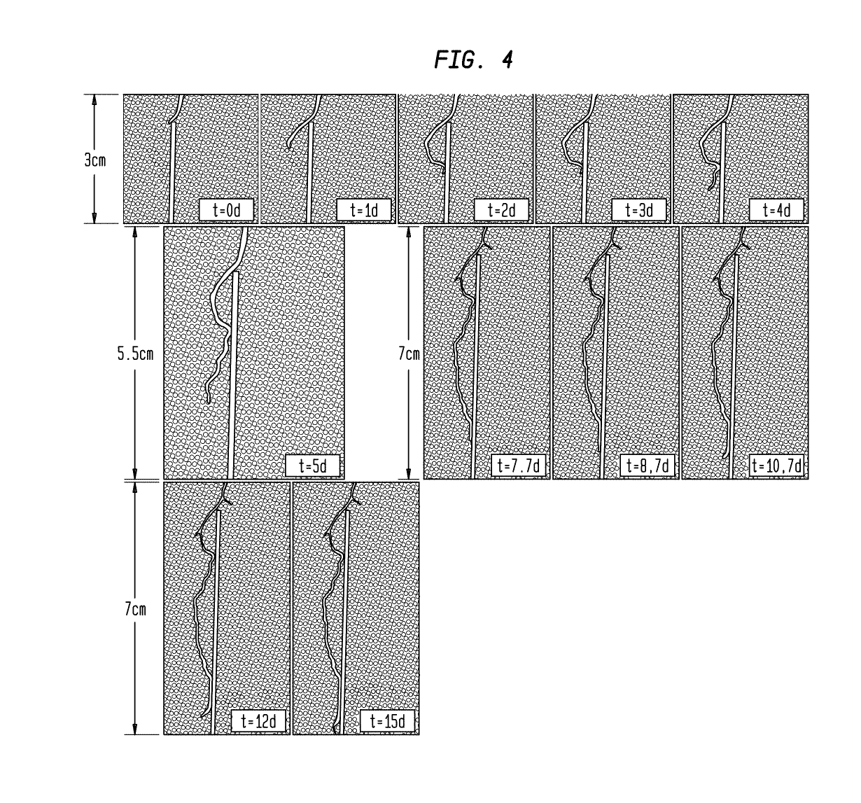

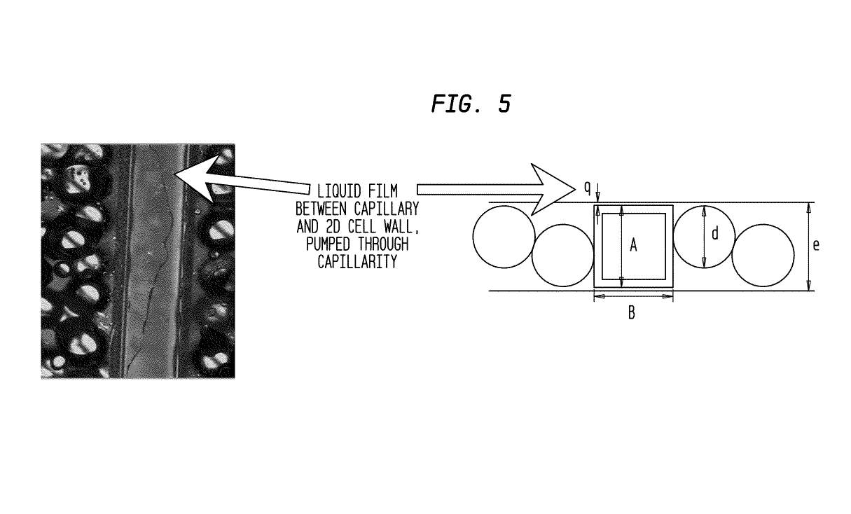

FIG. 4 is a photograph, in one embodiment, illustrating the growth-induced tropism proximate the root device over a period of 15 days. FIG. 5 is a depiction, in one embodiment, of a cross-sectional area of the root device in proximity to the surrounding medium. A small film of water is present along the outer surface area of the root device, promoting capillary action. In these set of experiments where the size of the intrusion is roughly equivalent to the thickness of the medium, the square configuration is preferred because it provides more area of contact with the 2D cell, allowing more water to flow. In addition, the packing immediately beside a square geometry provides less mechanical impedance for the root to grow.

FIG. 6 is a photograph, in one embodiment, of a 1 mm root device wherein a liquid film (illustrating capillary action) between the root device and surrounding medium, e.g., monolayer of glass beads as model soil (1 mm±0.2 mm).

Experiment II.

It has been observed that roots generally grow towards areas of greater water saturation. As a result, roots are able to use the water found or contained in these areas for further elongation. Referring generally to the figures, it is shown than roots develop in the presence of a structural intrusion. This structural intrusion is an inhomogeneity in the granular medium that modifies water distribution.

It has been observed, that structural intrusion modifies water distribution. As the partially saturated zone, or “PSZ”, develops during evaporation, a pressure gradient exists along the capillary liquid films in the PSZ, which drives flow of water upward. The PSZ consists of air-liquid interfaces whose curvature determines pressure distribution along two points in a liquid network. As the PSZ also develops, its PSZ saturation also decreases but capillary action along the intrusion wall or surface still exists. It is believed this is a result of the tiny area along the intrusion wall. Repeated experiments show that the roots “sense” this robust capillary action while the rest of the granular medium is desaturated from evaporation. As a result, the roots grow in the direction of the intrusion. Eventually, the roots should grow adjacent to the wall or surface of the intrusion.

Plant lifetimes were measured to increase in the presence of the intrusion. Plant lifetime is determined from image analysis, where a qualitative deterioration of plant shape and form such as wilting or dehydration suggests that the plant has already died. Measurement of the duration of the plant life before death in both experiments involving with and without intrusion show that the presence of the intrusion increases overall plant lifetime by approximately 1.5 times. This strongly suggests that as the PSZ recedes due to evaporation towards deeper portions of the cell, the effect of preferential intrusion also guides the roots deeper and allows them to stay within a PSZ. This allows the roots to proliferate further in the granular medium.

Experiment III.

Preferential tropism has been observed in the presence of solid rod intrusions. These intrusions however, have so far been strategically placed underneath the seed at t=0, to permit rather quick access to the intrusion, although in practice, roots sometimes initially deviate away before preferential tropism occurs. It is then interesting to determine the extent of how the root senses this intrusion. This poses the question that had the intrusions been placed at a certain distance away from the roots, the roots would be in theory placed in a predicament: would it choose to find the intrusion nevertheless or simply develop roots elsewhere. With this in mind, experiments were performed by varying the distance of the intrusion 1 cm away from the initial root on either side of the root. Results show that the root still develops towards the intrusion, aided mostly by its secondary roots. The intrusion was placed further at 2 cm away; no preferential tropism was observed at first, as it is believed the root system is too far and might need longer times to reach intrusion, although images do suggest the root slowly grows in the direction of the intrusion.

Furthermore, experiment were conducted altering the form of the intrusion in the 2D granular medium, by deliberately putting it in an oblique manne, e.g., at an angle relative to vertical. This experiment illustrates the competition between capillarity and gravity. Capillary action exists along the intrusion wall but because it is in a position that is slightly less favorable for root development, the root is now faced with the problem of either choosing to find the intrusion or responding to gravity and simply growing downward where water saturation is higher than the upper region.

Results again depict remarkable consistency of root elongation in the presence of solid square intrusions. Even in slanted positions, the root elongation shows preferential tropism towards and along the intrusion. This suggests that while roots grow in the direction of gravity, it mainly proliferates with the primary objective of water exploitation.

Experiment IV.

These root studies were performed in three-dimensional (3D) media and the root behavior with respect to the physical structure of the soil and the distribution of water within its pores were observed. Neutron imaging was utilized to to image root growth in 3D.

Different samples were imaged using neutron imaging, as summarized below in Table I, below. The roots are grown in granular material made of quartz sand and contained in thin-wall Aluminum cylinder pipes (McMaster Carr, New Jersey, USA), having 6 inches (15.24 cm) in height and a diameter of 1 inch (2.54 cm). The nature of the granular material was modified using chemical and physical treatments to observe how root respond to inhomogeneities in the granular medium in 3D space.

TABLE I

| | | |
|---|---|---|
| A | Control experiment. | Porous solid material |
| | Granular medium is not | with water |
| | subject to physical and | |
| | chemical modification. | |
| B | Granular medium with | Porous solid material |
| | porous device in the | with water |
| | center. This porous | |
| | device has a square | |
| | configuration and is filled | |
| | with much smaller pores | |
| | relative to the | |
| | surrounding granular | |
| | medium. The porous | |
| | device will be made of | |
| | sand of smaller size. | |
| C | Granular medium is a | Porous solid with water |
| | mixture of both | (hydrophobic treatment is |
| | hydrophilic-treated and | with silane solution) |
| | hydrophobic treated | |
| | material (50/50 ratio) | |

All set-ups were grown simultaneously in a laboratory under controlled ambient conditions, T=23±2° C., HR=45±5%, the same conditions as the 2D experiments.

Due to time and logistical limitations, only a portion of the entire length of the tube was imaged. The imaging view is about 5 cm in height situated about 1.5 cm below the surface.

Roots were grown in sand in the presence of a structural intrusion in the form of a granular column. The granular column consists of sand particles whose diameters are notably smaller than the rest of the medium. The smaller pore sizes of the particles in the granular column holds water while the rest of the water evaporates from the bulk in the same manner as previously explained. During the evaporation of a coupled heterogeneous media, water from larger pores evaporates first. In essence, the granular intrusion serves as a reservoir. Images suggest that roots seem to grow towards the intrusion by launching secondary roots in that direction. We can observe from the images the growth of secondary roots towards the intrusion. This further suggests that roots grow in the direction of greater water content generated by a structural intrusion, which corroborates previous experiments in 2D.

Experiments were conducted where a set-up of roots were grown in a random mixture of 50%/50% hydrophilic and hydrophobic sand. Water has completely evaporated and a robust root structure was observed as compared to roots simply grown in hydrophilic sand. This supports the idea that the addition of hydrophobic particles disrupts hydraulic liquid film flow and rather stores water in disconnected droplets. These droplets evaporate via the relatively slower process of diffusion and thus more water is kept inside the soil for longer periods in order for the plants to possibly use. Although quantitative measurements were not performed, we can nevertheless qualitatively deduce longer root lengths in a soil mixture of hydrophilic/hydrophobic particles than in hydrophilic particles alone.

It is understood that embodiments other than those expressly described herein come within the spirit and scope of the present claims. Accordingly, the invention described herein is not defined by the above description, but is to be accorded the full scope of the claims so as to embrace any and all equivalent compositions and methods.

1. A method of affecting a root system of a plant comprising:
inserting at least a portion of a root device in the ground proximate to a seed or plant,
the root device comprising a structure extending in a substantially longitudinal direction.

2. The method of claim 1 wherein affecting a root system comprises at least one of the following:
increasing root length of a plant;
inducing tropism of a plant root towards a water reservoir in soil;
promoting the growth of a root towards water in soil; or
increasing the lifespan of a plant.

3. The method of claim 1 wherein the root device has an average cross-sectional diameter of from 0.1 mm to 5 mm.

4. The method of claim 1 wherein the root device has an average cross-sectional diameter of from 0.2 mm to 3 mm.

5. The method of claim 1 wherein the root device has an average cross-sectional diameter of from 0.2 mm to 2 mm.

6. The method of claim 1 wherein the structure comprises a tube having a proximal end and a distal end and having at least one perforation.

7. The method of claim 6 wherein the at least one perforation has a diameter or width of less than 2 mm or 1 mm or 500 μm or 100 μm or 70 μm or 50 μm or 25 μm or 10 μm or 5 μm or 2 μm or 1 μm or 0.1 μm.

8. The method of claim 6 wherein the tube further comprises an inner wall and an outer wall.

9. The method of claim 6 wherein the perforation has a diameter or width of less than 50% of an average soil particle size in the soil.

10. The method of claim 6 wherein the tube has a substantially circular, square, oval, triangular cross-sectional area.

11. The method of claim 6 wherein the structure comprises at least one wall.

12. The method of claim 6 wherein the tube is substantially hollow.

13. A method of (i) increasing root length of a plant, (ii) inducing tropism of a plant root towards a water reservoir in soil, (iii) promoting the growth of a root towards water in soil, and/or (iv) increasing the lifespan of a plant comprising:
contacting a plant or a seed with soil; and
inserting at least a portion of a root device in the soil proximate to the seed or the plant, the root device comprising a structure extending in a substantially longitudinal direction.

14. The method of claim 13 wherein the structure comprises a tube having a proximal end and a distal end and having at least one perforation.

15. The method of claim 14 wherein the tube further comprises an inner wall and an outer wall.

16. The method of claim 13 whereby the root device induces tropism of a plant root towards a water reservoir in soil.

17. A method of (i) increasing root length of a plant, (ii) inducing tropism of a plant root towards a water reservoir in soil, (iii) promoting the growth of a root towards water in soil, and/or (iv) increasing the lifespan of a plant comprising:
inserting at least a portion of a root device in soil; and
contacting a plant or a seed to the soil at a location proximate to the root device;
wherein the root device comprises a structure extending in a substantially longitudinal direction.

18. The method of claim 17 wherein the structure comprises a tube having a proximal end and a distal end and having at least one perforation.

19. The method of claim 18 wherein the tube further comprises an inner wall and an outer wall.

20. The method of claim 17 whereby the root device induces tropism of a plant root towards a water reservoir in soil.

21. A method of inducing tropism of a root, the method comprising:
inserting at least a portion of a root device in soil proximate to a location wherein a seed or plant is contacted with the soil,
the root device comprising a structure extending in a substantially longitudinal direction.

22. A device for increasing the root length of a plant comprising a structure extending in a substantially longitudinal direction, and having a cross-sectional area comprising an outer wall and an inner wall.

23. The device of claim 22 wherein the cross-sectional area is substantially square, oval, circular, triangular in shape.
